(19) United States
(12) Patent Application Publication
(10) Pub. No.: US 2017/0247203 A1
(43) Pub. Date: Aug. 31, 2017

(54) LOADING DEVICE FOR LOADING AND/OR UNLOADING TRANSPORT CONTAINERS FOR PIECE GOODS AND METHOD FOR LOADING AND/OR UNLOADING TRANSPORT CONTAINERS FOR PIECE GOODS

(71) Applicant: SIEMENS AKTIENGESELLSCHAFT, MUENCHEN (DE)

(72) Inventor: PETER BERDELLE-HILGE, KONSTANZ (DE)

(21) Appl. No.: 15/301,515

(22) PCT Filed: Mar. 23, 2015
(86) PCT No.: PCT/EP2015/056058

§ 371 Date: Oct. 3, 2016

(30) Foreign Application Priority Data
Apr. 1, 2014 (DE) 10 2014 206 165.2

(51) Int. Cl. B65G 65/02; B65G 43/00; B65G 15/00

(52) U.S. Cl. CPC B65G 65/02; B65G 15/00; B65G 43/00

(57) ABSTRACT

A loading device for loading and/or unloading transport containers for piece goods includes a plurality of loading places at which the transport containers can be disposed and loaded or unloaded. At least one loading apparatus can be used for loading and/or unloading the transport containers at least at one loading place. In order to reduce the costs for the device, the device includes at least one positioning apparatus for moving at least one transport container or the loading apparatus from a first loading place to at least one second loading place. A method for loading and/or unloading transport containers for piece goods is also provided.

Loading device for loading and/or unloading transport containers for piece goods and method for loading and/or unloading transport containers for piece goods

The invention relates to a loading device for loading and/or unloading transport containers for piece goods with a number of loading places, at which the transport containers can be arranged and loaded or unloaded, and with at least one loading means, by means of which the transport containers can be loaded and/or unloaded at at least one loading place.

Furthermore, the invention relates to a method for loading and/or unloading transport containers for piece goods, in which a number of transport containers are arranged at loading places and are loaded or unloaded with the aid of at least one loading means.

Devices and methods of the said type are used to load or unload transport containers for piece goods. The transportation of piece goods, in particular in the form of stackable shipping units, such as parcels, bags, packaging, items of luggage, palleted products etc., currently takes place predominantly with the aid of standardized transport containers or transport units, which are preferably conveyed by road, rail or airplane. These transport containers are typically embodied here as exchangeable containers or trailers, which are known in specialist language under the term “swap containers” or “swap bodies”.

Over the last few years the increased movement of piece goods has also continuously increased the number of transport containers which have to be loaded and unloaded. In order to achieve higher throughputs when loading and unloading transport containers, a move has been made from the previously conventional manual loading and unloading to an at least partially mechanical process. Loading means are used here, which are embodied for the loading and/or unloading of piece goods. Such a loading means and a loading device for unloading transport containers is described in EP 2 444 341 A1 or WO 2011/133831 A1 for instance. The use of such loading means could significantly increase the throughput when loading and unloading the transport containers. However, the loading means are costly which results in significant acquisition costs.

The object underlying the invention is therefore to provide a loading device for loading and/or unloading transport containers for piece goods and a method for loading and/or unloading transport containers for piece goods of the type cited in the introduction, in which the costs associated with the loading and/or unloading are reduced in comparison with known embodiments.

This object is achieved by at least one positioning apparatus, which is embodied to perform a relative movement between the loading means and the transport containers, wherein the relative movement moves the transport containers from a secondary operating state into a loading state.

For the method cited in the introduction, the object is achieved in that the transport containers and the loading means are moved relative to one another and the transport containers are moved from a secondary operating state into a loading state by means of the relative movement.

The inventive solution is advantageous in that by means of the inventive positioning apparatus and the relative movement between the loading means and the transport containers, what are known as secondary operating times of the loading and/or unloading process can be performed at a distance from the loading means.

By moving from the secondary operating state into the loading state, the load factor of the costly loading means can be increased and as a result the overall costs of the loading or unloading process reduced.

The inventive solution can be further developed by advantageous developments, wherein the advantageous developments can be freely combined with one another.

A transport container in the loading state can thus be arranged at a loading place, to which the loading means is assigned, and in the secondary operating state at a loading place without assigned loading means. This is advantageous in that the secondary operating is separated from the loading place, at which the loading means is arranged, and the load factor of the loading means is increased as a result. In addition, there is also the advantage of a clear path for a loading or unloading of bulky goods being provided in the secondary operating state, because no loading means blocks or hinders access.

Furthermore, the positioning apparatus can be embodied to perform a relative movement between the loading places and the transport containers. This is advantageous in that the complicated design of the loading means which is often also difficult to move is always assigned to the same loading place, so that the conveyors assigned to the loading means for removing or delivering the items of piece goods, can be fixedly installed and integrated without the ability to move. Alternatively, the positioning apparatus can also be embodied to perform a relative movement between the loading places and the loading means. The transport containers can thus be assigned to fixed loading places and do not need to be moved.

Furthermore, a movement direction, in which the positioning apparatus moves, can run perpendicular to a loading direction, in which the loading means loads or unloads the transport containers. This is advantageous in that the transport containers can be loaded and unloaded in each position of the positioning apparatus. The loading direction runs identically to a delivery/removal direction, in which the transport containers are delivered to and removed from the loading places. The transport containers can therefore also be delivered and removed at each position of the positioning apparatus.

In order to prepare the next transport container, while the current transport container is already being loaded or unloaded by the loading means, the positioning apparatus can be embodied to simultaneously move at least two transport containers arranged on the positioning apparatus.

In an advantageous embodiment of the loading device, the first and second loading places are disposed adjacent to one another. This is advantageous in that the positions are disposed in close proximity to one another and a positioning time, which the positioning apparatus requires to move between two positions, is short. Furthermore, the ratio of the number of loading means to the number of loading places can be 2:5. This is advantageous in that less costly loading means have to be purchased and the loading means are utilized optimally.

In order to optimally fully load the loading means used in the loading device, the facility can have at least two positioning facilities, wherein the two positioning facilities are arranged so as to overlap, so that both positioning facilities can move a transport container on the same loading place in each case. A relatively short follow-up step, which is performed after loading and/or unloading by the loading means, can be performed in the secondary operating state on the overlapping loading place of the positioning facilities for instance. The space requirement of the inventive loading device is herewith advantageously reduced by one loading place.

In order to match the loading device optimally to the downstream and connected sorting system, the loading device can have at least two loading means and a controller for controlling the loading means and the positioning apparatus, wherein the controller is embodied such that the loading means loads or unloads the transport containers sequentially. The loading means can thus have the same throughput as the connected sorting system by the sequential work of the loading means not resulting in pile-ups when removing the piece goods into the sorting system.

In an advantageous embodiment of the afore-cited method, the transport containers can be loaded and/or unloaded in the loading state. The load factor of the costly loading means can thus be increased.

In order, in the method according to the invention, to be able to avoid pile-ups upon removal to the downstream sorting system, the transport containers can be loaded or unloaded by different loading means and the loading means can be controlled such that they operate sequentially in respect of one another.

The invention is explained below with respect to the appended drawings. The exemplary embodiments in the drawings are not to be regarded as restrictive to the invention,

in which:

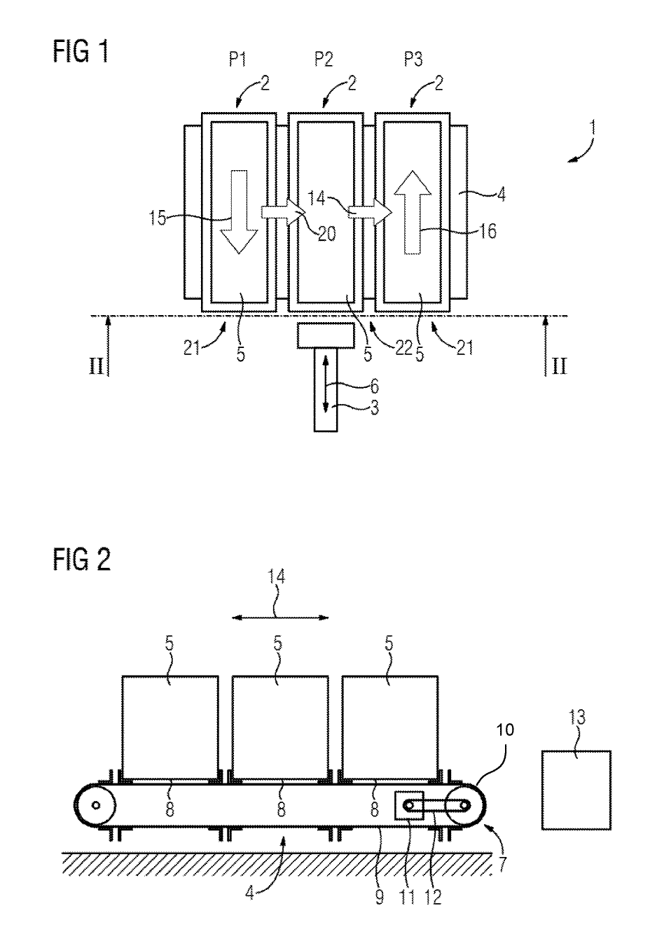

FIG. 1 shows a schematic top view of a first embodiment of the inventive facility for loading and/or unloading transport containers;

FIG. 2 shows a schematic side view of the embodiment of section A-A from FIG. 1;

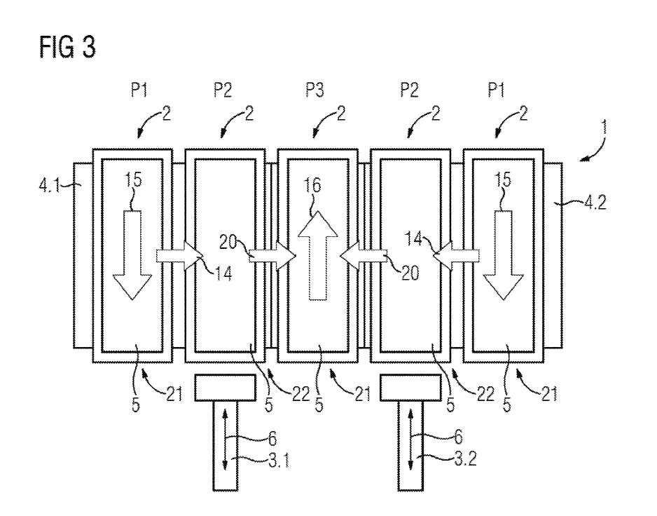

FIG. 3 shows a further embodiment of the inventive facility for loading and/or unloading transport containers;

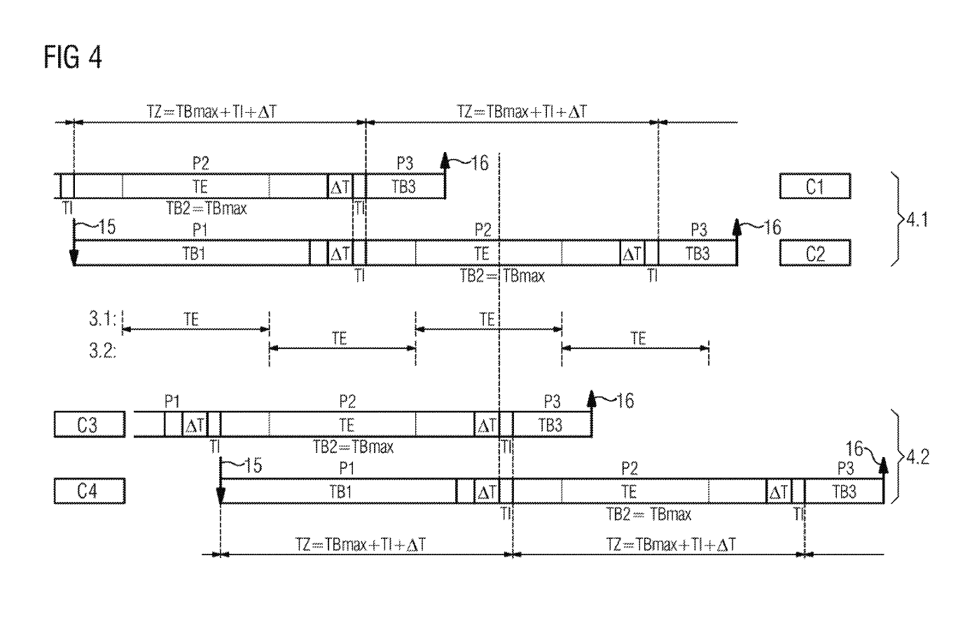

FIG. 4 shows a flow diagram relating to the embodiments in FIGS. 1-3;

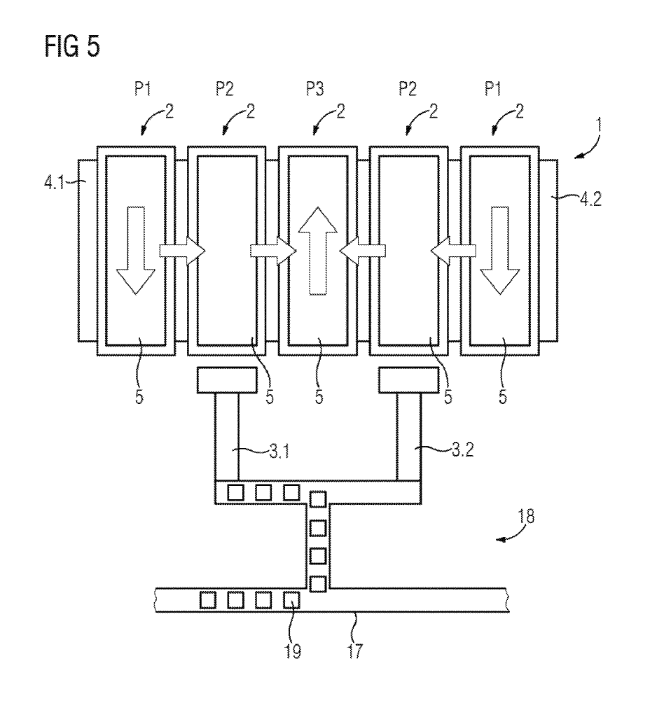

FIG. 5 shows a schematic representation of an inventive sorting system;

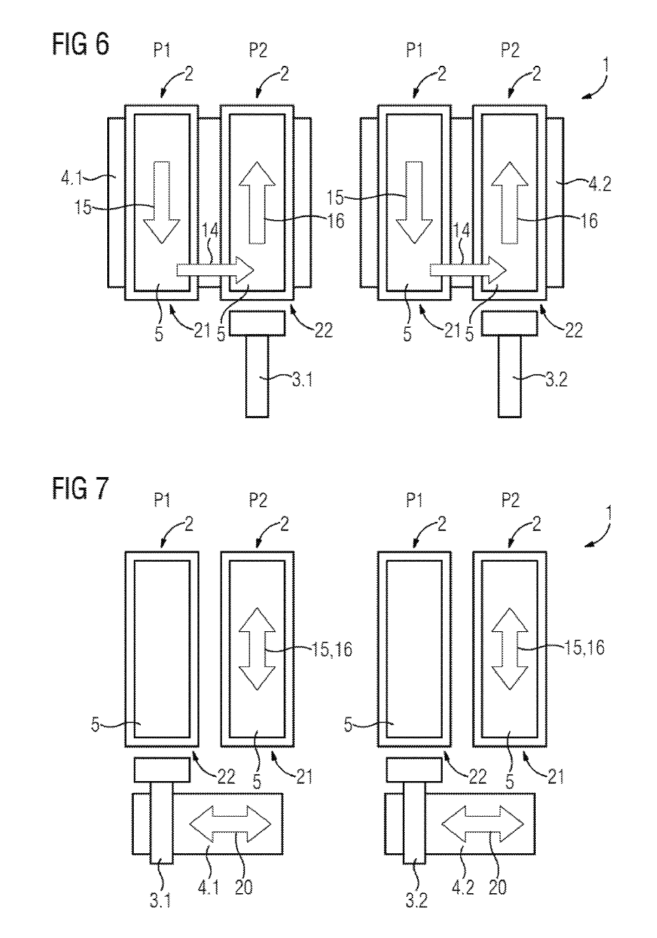

FIG. 6 shows a further embodiment of an inventive facility for loading and/or unloading transport containers;

FIG. 7 shows a further embodiment of the inventive facility for loading and/or unloading transport containers.

The invention is first described on the basis of the exemplary embodiment in FIGS. 1 and 2.

FIG. 1 shows an exemplary embodiment of an inventive loading device 1. The device 1 comprises three loading places 2, a loading means 3 and a positioning apparatus 4, on which three transport containers 5 are arranged.

The loading places 2 are disposed adjacent to one another and can have a loading ramp (not shown) in each case or collectively for instance, on which the transport containers 5 for loading and/or unloading are positioned. The loading places 2 are embodied in a known manner to load and/or unload a transport container 5 in each case. Known loading places 2 are described and shown in EP 2 444 341 A1 or WO 2011/133831 A1 for instance.

The loading means 3 is arranged at the middle loading place 2 in FIG. 1. The loading means 3 is only shown schematically and is embodied to automatically or at least semi-automatically load or unload a transport container 5. The loading means 3 is designed, in order to load or unload in a loading direction 6, to move into the middle transport container 5, at the loading place 2 of which the loading means 3 is arranged. The loading means 3 can be embodied as described in EP 2 444 341 A1 or WO 2011/133831 A1 and can have a floor-mounted conveyor or a moving carpet for instance.

The positioning apparatus 4 comprises a moving and drive unit 7 and a number of receptacles 8 which are shown in FIG. 2. In the exemplary embodiment in FIG. 2, the moving and drive unit 7 has a conveyor 9, such as for instance a conveyor belt, a chain drive or suchlike, deflection rollers 10 and a drive motor 11 with transmission 12. Receptacles 8 are fastened to the conveyor 9. The facility 1 further has a controller 13, which is connected by signaling to the drive motor 11 and controls the same. The receptacles 8 are arranged adjacent to one another on the conveyor 9. The receptacles 8 are embodied such that a transport container 5 can be received thereby and ensures a secure positioning. In the representation in FIG. 2, three transport containers 5 are received in three receptacles 8 of the positioning apparatus 4 which are disposed adjacent to one another. Alternatively, a positioning apparatus 4 without receptacles 8 is naturally also possible, in which the transport containers 5 are arranged directly on the conveyor.

With an actuation of the drive motor 11 by the controller 13, the conveyor 9 is moved in a movement direction 14, as a result of which a relative movement 20 between loading means 3 and the transport containers 5 and between the loading places 2 and the transport containers 5 is produced. Here the controller 13 is programmed such that the receptacles 8, which point upwards and which receive the transport containers 5 in FIG. 2, move in predetermined index positions. The index positions are programmed or mechanically fixed. The three index positions of the first embodiment in FIGS. 1 and 2 are shown in FIG. 1. The transport containers 5 shown are disposed in these index positions. The positioning apparatus 4 and the receptacles 8 are designed such that the transport containers 5 can be delivered onto the receptacle 8 in a delivery direction 15 and can be removed from the receptacle 8 again in a removal direction 16.

The transport containers 5 are embodied to transport piece goods, such as parcels or packages for instance, as are known in the prior art. In technical language, these transport containers 5 are also referred to as swap bodies or swap containers.

The inventive unloading method with the unloading facility 1 in FIGS. 1 and 2 is described below.

A first transport container 5 is firstly provided on the receptacle 8 in an index position P1. This transport container 5 is filled and is to be unloaded by the facility 1. In the position P1, in which the transport container 5 is in a secondary operating state 21, preliminary work is performed, which is needed before the loading means 3 can operate. This preliminary work is the delivery of the transport container 5, an identification of the transport container, opening of the doors of the transport container, removal of possible transport braces and possibly a manual unloading of non-machinable piece goods for instance. This preliminary work can sometimes be performed manually by an operator for instance.

The positioning apparatus 4 then moves the transport container 5 out of the first index position P1 into the second index position P2. In the embodiment in FIG. 1, the loading means 3 is arranged in this index position P2. The transport container 5 is moved into a loading state 22 by the relative movement 20. As soon as the transport container 5 has reached the index position P2, the loading means 3, possibly controlled by an operator, begins with the automatic or semi-automatic unloading of the transport container 5. Here the loading means 3 moves in the loading direction 6 into the transport container 5 and out again after unloading the piece goods. The loading means 3 can likewise be controlled by the controller 13. It can thus be ensured that the second index position P2 is firstly approached and the loading state is established before the loading means 3 starts.

While the first transport container 5 in the index position P2 is unloaded by the loading means 3, a next filled transport container 5 is provided in the index position P1, now available again, in the secondary operating state 21. The preliminary work is now performed on this second transport container 5, in parallel with the unloading of the first transport container 5, as was described above with reference to the first transport container 5. If the first transport container is unloaded by loading means 3, the preliminary work on the second transport container 5 is also concluded in the example in FIGS. 1 and 2 so that the positioning apparatus 4 can move the first transport container 5 to the third index position P3 and the second transport container 5 to the second index position P2. In other alternative embodiments of the invention, the preliminary work can also last longer than the loading or unloading. In any case, the positioning apparatus 4 only moves when the work taking the longest is concluded.

The second transport container 5 is now unloaded by the loading means 3. The first transport container 5 is post-processed in the third index position P3 in the secondary operating state 21 and then delivered in the delivery direction 16. The post-processing may be for instance a manual removal of remaining piece goods and the closing of the doors of the transport container 5. A third transport container 5 is provided on the index position P1 and the above-described preliminary work is performed in parallel with this post-processing on the first transport container 5 and the unloading of the second transport container 5. The method is thus operated further, so that the loading means 3 can operate with a greater load factor and has less idle times.

The temporal course of the described work by the inventive facility 1 on the first transport container 5 is shown graphically with the reference C2 in the time bar in FIG. 4.

The bar C2 shows the duration of the work on the first transport container 5 in the index positions P1, P2 and P3, starting with the delivery of the transport container 5 in the delivery direction 15 up to the removal in the removal direction 16. Time TB1 represents the duration of the preliminary work, time TB2 represents the duration of the unloading process by the loading means 3 and time TB3 represents the duration of the post-processing in position P3. In time TB2, the transport container is in the loading state 22, in times TB1 and TB3 it is in the secondary operating state 21. Since the unloading process in the position P2 takes the longest compared with the work in positions P1 and P3, TB2 is also shown as TBmax. The time in the position P2, in which the loading means 3 actually removes piece goods, is referred to with TE. Since certain preliminary work and rework is also required in position P2, which can however only be performed in station P2, the time TE is less than TB2. The achievable throughput of the unloading corresponding to the cycle time TZ is, in addition to the pure unloading time TE, only still determined here by the times of the preliminary work and rework on the position P2 and the shift time of the container 5, and not by all other secondary operating times. As a result, the number of loading means 3.1, 3.2 required is correspondingly less than when a correspondingly large number of loading means 3.1, 3.2 are used in parallel with the same overall throughput.

A further embodiment of the inventive loading and/or unloading facility 1 is described below with reference to FIG. 3. For the sake of simplicity, only differences from the embodiment in FIG. 1 are shown.

The facility 1 in FIG. 3 comprises two positioning apparatuses 4.1, 4.2 and two loading means 3.1, 3.2 and has five loading places 2. The positioning apparatuses 4.1, 4.2 are arranged and designed such that they move in opposite movement directions 14 and overlap in the index position P3 in each case. In other words, the positioning facilities 4.1, 4.2 can both approach the shared position P3. Otherwise, the course of actions or work in the index positions P1, P2, P3 are described as above with reference to the embodiment in FIG. 1.

Both positioning apparatuses 4.1, 4.2 are controlled by the controller 13, which controls it as shown in FIG. 4. Here the course of actions of the first positioning apparatus 4.1 in the upper area and the positioning apparatus 4.2 in the lower area of FIG. 4 is shown. The time bars C1, C2, C3, C4 represent the processing of the various transport containers 5. The activation, in other words indexing, of the two positioning apparatuses 4.1, 4.2 is performed by the controller 13 such that the loading means 3 do not unload piece goods simultaneously, but instead always one after the other, in other words sequentially, as shown in the middle area of FIG. 4. Furthermore, the positioning apparatuses 4.1, 4.2 are controlled such that only one positioning apparatus moves a transport container 5 into the position P3 in each case. This is possible without throughput decreases, since compared with the work at the stations P1 and P2, the rework is shorter. A shared index station P3 can thus be used, as a result of which a loading place 2 can be saved compared with two devices 1 according to the embodiment in FIG. 1.

FIG. 5 shows the connection of the facility 1 in the embodiment in FIG. 3 to a transport system 17 of a piece goods sorting system 18. Here the piece goods 19 are supplied by the loading means 3.1, 3.1 to the transport system 17 of the piece goods sorting system 18 in each case for further transportation. Here the throughput of the loading means 3.1, 3.2 is equal to the throughput of the transport system 17. Since the two loading means 3.1, 3.2 of the inventive facility 1, as described above, only convey sequentially (FIG. 4), the piece goods 19 can be discharged continuously by the transport system 17. With a parallel unloading of the loading means 3.1, 3.2, the piece goods 19 would pile up in a negative way and may not be removed continuously.

The exemplary embodiment of the inventive facility 1 is described below in FIG. 6. FIG. 6 shows two devices 1, which each have a positioning apparatus 4.1, 4.2, which each only approach two index positions P1, P2. Here in positions P1 the work is performed, as described above, for the embodiment in FIG. 1. However, in the embodiment in FIG. 6, the work performed in the index position P2 is the work which is performed above for the embodiment in FIG. 1 in the index positions P2 and P3, in other words the unloading by the loading means 3, the rework and the removal. In this position P2, the transport container 5 is in the loading position 22. In FIG. 6, two devices 1 are shown adjacent to one another. It would also be conceivable for the device 1 to comprise a single facility 1, in which the two positioning apparatuses 4.1, 4.2 in FIG. 6 are controlled by a shared controller 13.

Finally, a further embodiment of the inventive loading and/or unloading facility 1 is described with reference to FIG. 7.

In the embodiment in FIG. 7, it is not the transport containers 5, but instead the loading means 3.1, 3.2 which are arranged on a positioning apparatus 4.1, 4.2. Accordingly, the receptacles 8 of the positioning apparatuses 4.1, 4.2 are designed to receive loading means 3.1, 3.2. The inventive loading and/or unloading method is described below with reference to the embodiment in FIG. 7.

Full transport containers 5 are first provided in both index positions P1, P2. The afore-cited preliminary work is performed in the index position P1 and then the first transport container 5 in position P1 is unloaded by the loading means 3.1, 3.2. The transport container 5 is in the loading state 22. The preliminary work is performed on the second transport container 5, which is in the secondary operating state, in the second index position P2 in parallel to the unloading process by the loading means 3.1, 3.2. Then, if the unloading process is concluded, the positioning apparatus 4.1, 4.2 moves the loading means 3.1, 3.2 into the next index position P2. The relative movement 20 causes the transport containers 5 to move from the loading state 22 into the secondary operating state 21 and vice versa. In this index position P2, the unloading process of the second transport container 5 is now performed. The rework can be performed in parallel with this second unloading process and the transport container 5 can be removed.

In FIG. 7, two facilities 1 are shown adjacent to one another. It would also be conceivable for the apparatus 1 to comprise a single facility 1, in which the two positioning apparatuses 4.1, 4.2 in FIG. 6 are actuated by a shared controller 13.

1-12. (canceled)

13. A loading device for at least one of loading or unloading transport containers for piece goods, the loading device comprising:
a plurality of loading places at which the transport containers can be disposed and loaded or unloaded;
at least one loading apparatus for at least one of loading or unloading the transport containers at least at one of said loading places; and
at least one positioning apparatus configured to perform a relative movement between said at least one loading apparatus and the transport containers, said relative movement transferring the transport containers from a secondary operating state into a loading state.

14. The loading device according to claim 13, wherein said at least one positioning apparatus is configured:
to place a transport container in said loading state at one of said loading places to which said at least one loading apparatus is assigned, and
to place a transport container in said secondary operating state at one of said loading places without an assigned loading apparatus.

15. The loading device according to claim 13, wherein said at least one positioning apparatus is configured to perform a relative movement between said plurality of loading places and the transport containers.

16. The loading device according to claim 13, wherein said at least one positioning apparatus is configured to perform a relative movement between said plurality of loading places and said at least one loading apparatus.

17. The loading device according to claim 13, wherein:
said at least one loading apparatus loads or unloads a transport container in a loading direction; and
said at least one positioning apparatus moves in a positioning direction running perpendicular to said loading direction.

18. The loading device according to claim 13, wherein said at least one positioning apparatus is configured to simultaneously move at least two of the transport containers disposed on said at least one positioning apparatus.

19. The loading device according to claim 13, wherein said at least one loading apparatus is a plurality of loading apparatuses, and a ratio of said plurality of loading apparatus to said plurality of loading places is two to five.

20. The loading device according to claim 13, wherein said at least one positioning apparatus is at least two positioning apparatuses, and two of said positioning apparatuses overlap each other permitting each of said two positioning apparatuses to move a transport container on the same one of said plurality of loading places.

21. The loading device according to claim 13, wherein:
said at least one loading apparatus is at least two loading apparatuses;
a controller controls said at least one loading apparatus and said at least one positioning apparatus; and
said controller is configured to cause said at least one loading apparatus to load or unload the transport containers sequentially.

22. A method for at least one of loading or unloading transport containers for piece goods, the method comprising the following steps:
placing a plurality of transport containers at loading places;
loading or unloading the plurality of transport containers by using at least one loading apparatus;
moving the transport containers and the at least one loading apparatus relative to one another; and
transferring the transport containers from a secondary operating state into a loading state by the relative movement.

23. The method according to claim 22, which further comprises at least one of loading or unloading the transport containers in the loading state.

24. The method according to claim 22, which further comprises:
loading and unloading the transport containers by using different loading apparatuses; and
controlling the loading apparatuses to operate sequentially.
